(19) United States
(12) Patent Application Publication
(10) Pub. No.: US 2006/0041869 A1
(43) Pub. Date: Feb. 23, 2006

(54) System and method for analyzing consumer specified issues associated with a software application

(76) Inventors: Seth Houston, Lansdale, PA (US); Fred Figg, Schwenksville, PA (US); Domenic J. Bonanni, Drexel Hill, PA (US)

Correspondence Address: BAKER & BOTTS, 30 ROCKEFELLER PLAZA, NEW YORK, NY, 10112, US

(21) Appl. No.: 11/245,525

(22) Filed: Oct. 7, 2005

Related U.S. Application Data
(63) Continuation of application No. PCT/US03/12448, filed on Apr. 7, 2003.

(51) Int. Cl. G06F 9/44

(52) U.S. Cl. 717/131; 717/101

(57) ABSTRACT

A system and method for resolving a service request is described. The method including receiving a service request including information describing select attributes of the current condition of a software application initiated by a user, and sending a service request response describing at least one reason for the current condition of the software application.

### BACKGROUND OF THE INVENTION

1. Technical Field

The present invention relates to the resolution of issues or problems associated with a software application, and more particularly, to the resolution of issues presented during use of a software application with particular data describing the condition of the software application and/or the information, data or files associated therewith at the time the issue occurred and the issue or problem as described in text entered by the user of the software application.

2. Background Art

Software developers and vendors (hereinafter “Developers) continually strive to make their products and services more user friendly, understandable, and problem free. Batteries of tests are performed during development, followed by alpha and beta releases to certain customers for further testing. The certain customers inform the Developers of additional problems, not uncovered by the quality assurance engineers, with the software and issues concerning the usability of the user interface. User interface problems present themselves when someone unfamiliar with the software application or the data or files associated with the application uses certain unfamiliar functionality of the products. The data or files associated with the application include third party databases, data files integral to the software application, and the like. Developers continually strive to improve the usability of the software applications and the data or files upon which they work, but usability of the software application continues to be an ongoing concern.

Following the alpha and beta trials, the software application is released to the public. Upon public release, the software application may have certain mechanisms to allow customers to obtain answers to certain questions about the application. Over time, different mechanisms for improving the usability of software applications have been developed, some include automatic bug reports, help files, and generally customer service centers.

Automated bug reports do not help a customer to understand better how to use the software application, but do allow the software manufacturer to become aware of issues presented in the application and eventually resolve the issues. Automated bug reports generally occur following an error condition triggered in the software. This error condition could be an erroneous memory fault, a file protection error, and the like. Once the error condition is triggered, the software application may ask the user if they wish to file a bug report or close out of the application. If they wish to file the bug report, the software application sends a message to the Developer describing the conditions upon which the error condition was triggered, but does not capture the condition of any information, data or files in use with the software application at the time the issue presented. Unfortunately, these bug reports are not customer initiated, they are initiated by an error condition imbedded in the software, and the Developer does not report back to the customer educating the customer in order to educate the customer to better use the software, such that the problem does not happen in the future.

Help files allow users to look up information pertaining to certain functions of the software application. Help files may provide users with answers to customer specified questions or allow a customer to look through a software application manual for information. However, these help files are not generally very user friendly and are dependant on keywords or hierarchical organization used by the user to call up a help file. If the user is not familiar with the proper keyword or location within the hierarchical organization, the search of the help files will result in a return of help files irrelevant to the issue presented or the user's actual need.

Alternatively, some software manufacturers provide customer service operators who are available to answer questions. These customer service operators are generally well trained and can answer many of the questions asked by customers about their area of expertise. Unfortunately, many of the problems experienced by users of software applications are situation specific and in many cases customer specified data specific. The customer using the software application must painstakingly describe the problem he or she is confronted with and hope that the customer service operator has the knowledge to answer the question. All too often, especially as the tests run by the quality assurance engineers improve, the customer service operator cannot answer the question posed by the customer without access to the particular data, information or files being worked on by the customer or without access to the computer the customer is working on because the problems experienced by customers are increasingly instance, information, data or file specific.

Accordingly, there exists a need for a customer driven technique able to specify information describing an issue or problem encountered by a customer to a customer service agent in order to allow issues presented, when using software application and associated information, data or files, to be resolved by an appropriate, knowledgeable customer service agent.

### SUMMARY OF THE INVENTION

An object of the present invention is to provide a customer driven technique able to automatically specify information describing an issue or problem encountered by a customer to a customer service agent in order to allow the situation to be resolved by an appropriate, knowledgeable customer service agent.

A further object of the present invention is to provide a technique whereby the user is not required to painstakingly define the conditions under which the user experienced the issue or problem to a customer service representative or specialist.

It is also an object of the present invention to provide a technique for a providing a customer specific archive of past issues or problems and the solutions thereto, accessible to the user.

In order to meet these objectives and others that will become apparent with reference to the disclosure below, in one exemplary embodiment of the present invention, a method and logic arrangement are provided for resolving a service request. The method includes receiving a service request including information describing select attributes of a software application, information, data or files in use by a user, generating a service request response, and sending the service request response to the received service request describing at least one reason for the current condition of the software application, information, data or files in use.

In another exemplary embodiment of the present invention, a system for resolving a service request is provided. The system includes a server and a data analysis system. The server is configured to receive a service request including information describing select attributes of a software application initiated by a user, to generate a service request response, and to send a service request response describing at least one reason for the current condition of the select attributes of the software application. The server includes a processor and a database. The processor is configured to generate tracking information describing various attributes of the service request, assign a data analysis specialist to review the service request, and generate a service request analysis message based upon the information contained within the service request. The database is coupled to the processor and configured to store the information contained in the service request and the tracking information in a service request record on a data storage device. The data analysis system is in communication with the server and configured to receive the service request analysis message and send a service request analysis response generated by the data analysis specialist, wherein the processor receives the service request analysis response and generates the service request response based upon the information contained within the service request analysis response.

The accompanying drawings, which are incorporated and constitute part of this disclosure, illustrate preferred embodiments of the invention and serve to explain the principles of the invention.

### BRIEF DESCRIPTION OF THE DRAWINGS

FIG. 1 is a block diagram of an exemplary system for opening a service incident report and receiving information pertaining to that particular service incident report from a data analysis specialist in accordance with an embodiment of the present invention;

FIG. 2. is a flow chart of a user driven process for opening or reviewing a service incident in accordance with the present invention;

FIG. 3A is a flow chart illustrating a process for receiving service incidents from client systems in accordance with the present invention;

FIG. 3B is a flow chart illustrating a process for receiving proposed resolutions, requests for additional information, or other status updates concerning service incidents analyzed by a data analysis system in accordance with the present invention; and

FIG. 4 is a flow chart of a process for receiving data analysis service incident messages from an application server and processing the data analysis service incident messages in accordance with the present invention.

Throughout the drawings, the same reference numerals and characters, unless otherwise stated, are used to denote like features, elements, components or portions of the illustrated embodiments. Moreover, while the present invention will now be described in detail with reference to the Figs., it is done so in connection with the illustrative embodiments.

### DETAILED DESCRIPTION OF THE PREFERRED EMBODIMENTS

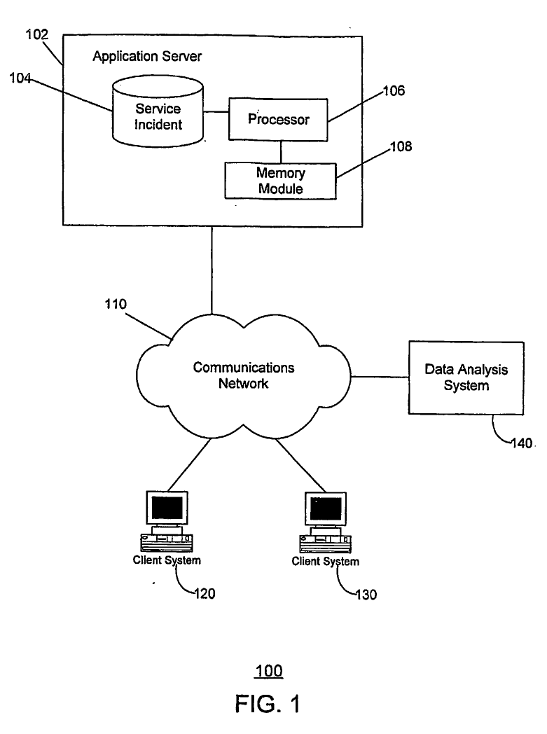

Referring to FIGS. 1-4, an exemplary embodiment of the present invention will be described. FIG. 1 illustrates a block diagram of a service incident reporting and resolution system 100. The service incident system 100 allows a user to open a service incident report and receive information pertaining to that particular service incident report from a data analysis specialist. The user initiates this process by logging into a software application. The user may use the software application to process data, generate reports, and the like. Upon discovery of an issue or problem with either the functionality of the software application, certain information, files or processed data, generated reports or the like, the user may submit a service incident report describing the condition of the software application, information data, files or reports and certain other information detailed by the user.

The service incident system 100 includes an application server 102, a communications network 110, a client system 120, a client computer 130, and a data analysis system 140. The application server 102 provides software applications to the client systems 120, 130 for execution on the client systems 120, 130 receives information relating to service incidents, stores information relating to service incidents in the service incident database 104, transmits information describing service incidents to the data analysis system 140, and receives status or resolution information from the data analysis system 140. The application server 102 transmits information to and receives information from the client systems 120, 130 and the data analysis system 140 via the communications network 110. Preferably, the communications network 110 is the internet or a virtual private network between client and Developer.

The client system 120 receives and transmits information relating to the software application. If a user desires to execute a software application not currently stored on the client system 120 or if an update to the software application is required prior to execution, the client system 120 downloads and stores the software application or update to the software application from the application server 102. Once a valid copy of the software application is stored, the client system 120 begins execution thereof. During execution of the software application, the user may encounter an issue using the software application or an issue interpreting data, information, files, reports, documents, or the like. If the user encounters such an issue, the user may open a service incident by initiating a service incident report. Upon opening of a service incident, the client system 120 transmits a message to the application server 102 describing the current condition of the software application, data, reports, information, documents, and the like, and any additional information provided by the user.

In a preferred embodiment, the software application is executed on the application server 102, and information is displayed to the client system 120. In another preferred embodiment, the software application is a web application, and as such is executed on the application server 102, and information is displayed to the client system 120.

The application server 102 provides information to and stores information received from the client systems 120, 130 and the data analysis system 140. The application server 102 includes a service incident database 104, a processor 106 and a memory module 108. The service incident database 104 stores all information received pertaining to each service incident in a respective service incident record. The memory module 108 stores each of the software applications along with other data. The processor 106 interfaces with the communications network 110, the service incident database 104, and the memory module 108 in order to respond to requests and/or transmissions from the client systems 120, 130 and the data analysis system 140.

In a preferred embodiment, the memory module 108 includes volatile and nonvolatile memory. In another preferred embodiment, the memory module 108 includes a hard disk drive.

The data analysis system 140 receives information about each of the service incidents stored in the service incident database 104 and provides information to the application server 102 describing ways to resolve each of the service incidents, requests for additional information, and indications of which service incidents are irresolvable. The data analysis system 140 includes many specialist terminals configured to display information pertaining to a specified service incident. Data analysis specialists review this information and describe proposed solutions to the issues specified in the service incidents, requests for additional information, and indications of which service incidents are irresolvable which is then transmitted to the application server 102.

In a preferred embodiment, multiple data analysis systems 140 are utilized. In another preferred embodiment, each data analysis system 140 includes a single specialist terminal.

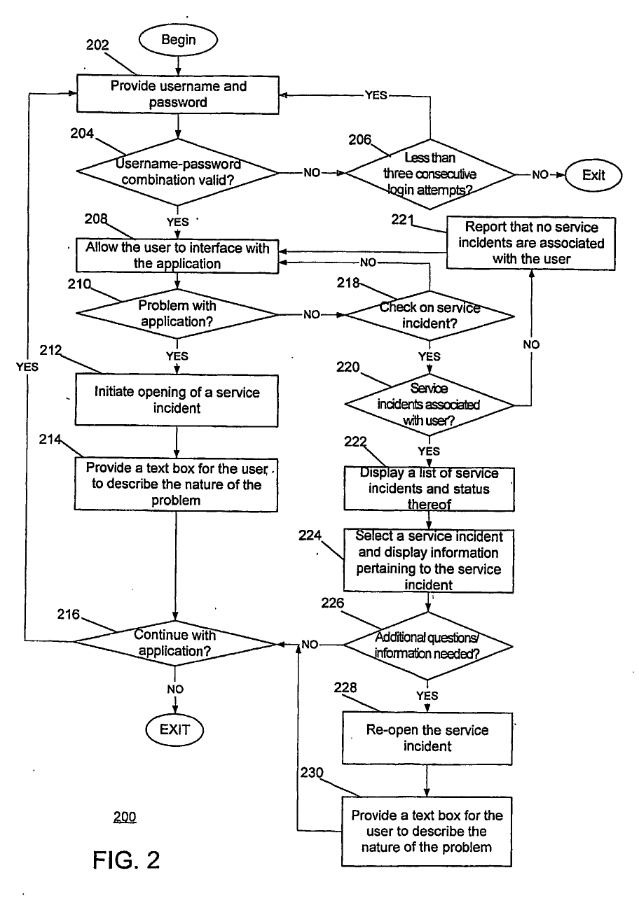

FIG. 2 illustrates a user driven process 200 for opening or reviewing a service incident. A service incident is a report, eventually transmitted to the application server 102, describing an issue or problem a user is having with a software application that shall be reviewed by a data analysis specialist for resolution and reporting back to the user. The issue with the software application can be related to the usability of the software application, the particular data being presented to the user, or the like. The process 200 begins at step 202 by providing a username-password combination. The customer provides the username-password combination, clicks on a login button, and the process 200 advances to step 204.

At step 204, the process 200 determines if the username-password combination was recognized by the application server 102. If the username-password combination was recognized, the process 200 advances to step 208. If the username-password combination was not recognized, the process 200 advances to step 206. At step 206, the process 200 determines whether the customer has attempted to log into the system at least three consecutive times. If the customer has attempted to log into the system less than three consecutive times, the process 200 advances to step 202, and the customer is allowed to attempt to log into the system again. Otherwise, the process 200 exits.

At step 208 the user utilizes the functionality of the software application. The user may specify queries for desired data, files, information, format reports, analyze data or files presented or accessed by the software application, and the like. While performing these operations, the user may encounter an issue with the software application or an issue in understanding or using data, information or files presented or accessed by the software application. If the user experiences no issue or problem with the software application, data, information, or files, the process advances to step 218, as shown at step 210. If the user encounters an issue or problem with the software application or a question about the data being presented, the user may elect to open a service incident by clicking on an appropriate help button. If the user clicks on the appropriate help button, the process 200 advances to step 212.

In a preferred embodiment, the appropriate help button may be replaced by an appropriate menu option, hyper-link, or alternative software object.

At step 212, the process 200 initiates the opening of the service incident. The process 200 collects information describing the current condition of the software application, including the information, data or files displayed on the screen, the current work product, the current state of the software application, along with other parameters or variables describing the current status of the client system 130. The current work product could be a document, a spreadsheet, a report, a database, and the like. For example, if a user was using a report generating application, where the user specifies particular data queries and the report generating application generates a report based on the responses to the data queries from a group of continually changing databases, the current work product would be the particular report, based on the information contained in the group of databases current as of the time the particular data queries were executed. The current state of the software application may include a history of actions taken by the user, the current software application options selected by the user, the current status of the controls operating on the current work products, the current software application options for this instance of the software application, the global default software application options for each instance of the software application and the like. For purposes of this application, an instance of the software application is a process executing the software application. Once the process 200 collects the appropriate information, the process 200 advances to step 214.

At step 214, the process 200 presents the user with a text box. The user is prompted to describe the issue presented to the user. The user can ask questions about the particular data the user is analyzing, the functions of the software application, and the like. Once the user specifies his or her question, the user submits the service incident. The process 200 transmits the information describing the service incident to the application server 102 for the application server 102 to open a new service incident record in the service incident database 104.

At step 216, the user determines whether he or she would like to continue using the software application. If the user decides to terminate the application, the process 200 exits. Otherwise, the process 200 advances to step 208.

At step 218, the user determines whether he or she would like to check on the status of an open service incident. If the user elects not to check on the status of an open service incident, the process 200 advances to step 208. If the user elects to check on the status of an open service incident, the process 200 advances to step 220.

At step 220, the process 200 determines if any service incidents are associated with the user. If no service incidents are associated with the user, the process 200 advances to step 221. The process 200 informs the user that no service incidents are associated with the user, and the process 200 advances to step 208. If at least one service incident is associated with the user, the process 200 advances to step 222.

At step 222, the process 200 displays a list of service incidents opened by the user and the status of each of them. The user can select and review each of the service incidents to review the information provided and the proposed solution for each service incident at step 224. Once the customer selects a service incident, the process 200 presents the user with the information collected upon opening of the service incident, the question or questions provided by the user during the initial opening of the service incident or at subsequent times, and a proposed solution to the issue, a request for additional information, or an indication that the service incident is irresolvable. The solution is a proposed solution, because the information provided by the data analysis specialist may resolve a service incident, while other service incidents may remain unresolved even though information was provided by the data analysis specialist in the hopes of resolving the service incident.

Upon review of the proposed solution to the service incident, the user may not understand the proposed solution to the issue, the proposed solution may not rectify the issue to the user's full satisfaction or the proposed solution may raise additional questions. At step 226, the user may elect to ask additional questions about the service incident. If the user elects to ask additional questions, the process 200 advances to step 228. Otherwise, if the user is satisfied with the proposed solution, the client system 130 sends a message to the application server 102 indicating that the service incident is closed, and the process advances to step 216.

At step 228, the process 200 re-opens the service incident. The process 200 collects the information describing the original service incident and any additional information that may exist, including any user provided information. After the process 200 collects this information, it presents the user with a text box. The user is prompted to describe the nature of the issue in the text box provided on the screen at step 230. After the user describes the nature of the issue, the newly updated service incident is transmitted to the application server 102, and the process 200 advances to step 216.

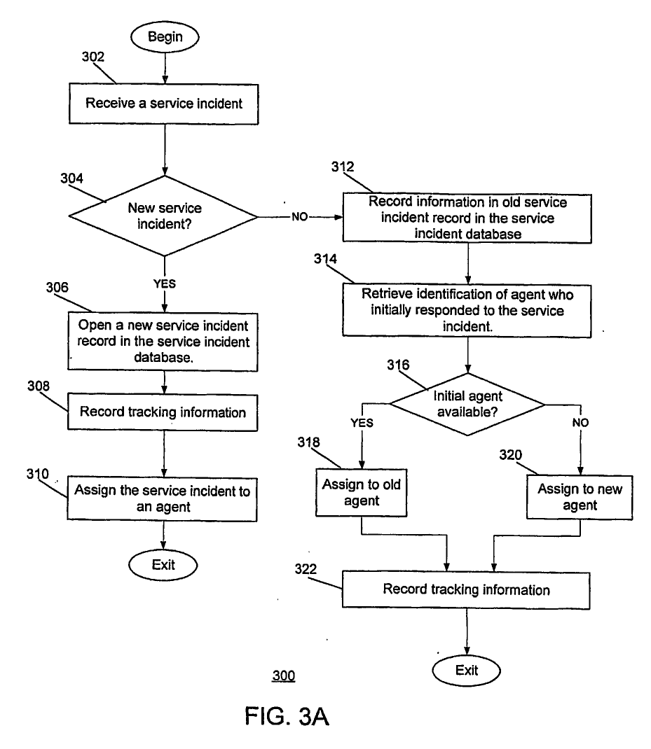

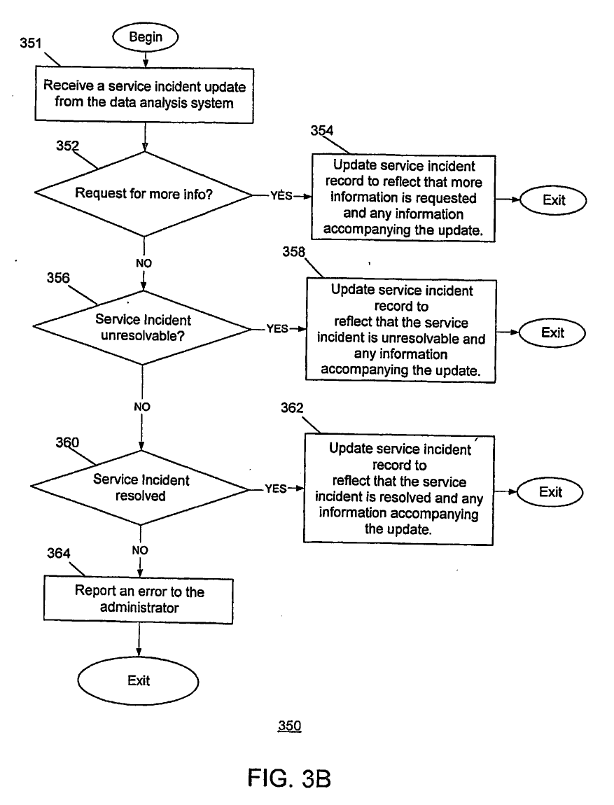

FIG. 3A illustrates a process 300 where the application server 102 receives service incidents from the client systems 120, 130. The process 300 begins at step 302 when the application server 102 receives a service incident message from either of the client systems 120, 130. The service incident message contains information describing a service incident. The service incident can be new or can be a request for additional clarification of an existing service incident. At step 304, the process 300 determines if the service incident message contains information describing a new service incident or an existing service incident. If the message contains information describing a new service incident, the process 300 advances to step 306. Otherwise, the process 300 advances to step 312.

In a preferred embodiment, the process 300 may be one of many customer relationship management (“CRM”) software tools. In another preferred embodiment, the process 300 is the Onyx CRM software tool, which is available from Onyx Software, 3180 139th Ave SE, Suite 500, Bellevue, Wash. 98005-4091.

At step 306, the application server 102 opens a new service incident record in the service incident database 104. Upon creation and population of the new service incident record, the service incident database 104 will contain information collected by the process 200, including the state of the software application the information provided by the user. The process 300 logs additional information into the service incident record, including an indication that the status of the service request is currently unresolved, an identifier indicative of the software application that originated the service incident, the time the service incident was received by the application server 102, the type of issue represented by the service incident (if discernable by the information describing the state of the software application), the time the service incident was resolved (which is initialized to a known value along with additional service incident tracking information), and the like.

At step 310, the application server 102 assigns and transmits the service incident to a data analysis specialist. The assignment to a data analysis specialist is in part based on the time of receipt, the type of issue represented by the service incident, the software application that originated the service incident, and availability of data analysis specialists. Once the service incident is assigned to a particular data analysis specialist, the application server 102 updates the service incident record to reflect the selected data analysis specialist and transmits a data analysis service incident message containing the information contained by the service incident record to the data analysis specialist at the data analysis system 140 and the process 300 exits.

At step 312, the application server 102 determines what information needs to be added to the service incident record in the service incident database 104. The application server 102 accomplishes this by comparing the information contained in the service incident message against the information contained in the service incident record. The application server 102 adds the new information to the service incident record and updates the status to reflect that the service incident is unresolved. The process 300 also logs another set of additional information into the service incident record, reflecting the new addition to the service incident, including the time the new addition to the service incident was received by the application server 102, the type of issue represented by the new addition to the service incident (if discernable by the information describing the state of the software application), the time the new addition to the service incident was resolved (initialized to a known value), and the like. This another set of additional information does not overwrite the additional information added to the service incident record upon the receipt of previous service incident message or messages.

At step 314, the process 300 retrieves the information identifying the data analysis specialist who worked on the service incident previously. Once the previous data analysis specialist is identified, the process 300 determines whether the same data analysis specialist is available at step 316. The same data analysis specialist is available if the specialist is currently logged-in to at the data analysis system 140. If the data analysis specialist is currently available, the process 300 advances to step 318, assigns the service incident to the same data analysis specialist, transmits a data analysis service incident message, and exits. This allows the data analysis specialist who is most acquainted with the issue to provide additional help to the user. Otherwise, the process 300 advances to step 320.

At step 320, the application server 102 assigns and transmits the service incident to a new data analysis specialist. The assignment to a data analysis specialist is in part based on the time of receipt, the type of issue represented by the service incident, the software application that originated the service incident, and availability of data analysis specialists. Once the service incident is assigned to a particular data analysis specialist, the application server 102 updates the service incident record to reflect the selected data analysis specialist and transmits a data analysis service incident message containing the information contained by the service incident record to the data analysis specialist at the data analysis system 140 and the process 300 exits.

FIG. 3B illustrates a process 350 where the application server 102 receives proposed resolutions, requests for additional information, or other status updates concerning service incidents analyzed by the data analysis system 140. The process 350 begins at step 351 when the application server 102 receives a data analysis service incident update message from the data analysis system 140. The data analysis service incident update message contains information describing a service incident and additional information associated with the service incident provided by a data analysis specialist at the data analysis system 140. The additional information associated with the service incident may request additional information, report that the service incident is irresolvable, describe a proposed resolution, or the like.

At step 352, the process 350 determines whether the data analysis service incident update message contains a request for additional information. If the update message contains such a request, the process 350 advances to step 354. At step 354, the service incident record is updated to reflect the data analysis specialist's request for additional information. Once the service incident record is updated, the process 350 exits. If the update message does not contain a request for additional information, the process 350 advances to step 356.

At step 356, the process 350 determines whether the data analysis service incident update message contains information indicating that the service incident is irresolvable. If the update message contains information reporting that the service incident is irresolvable, the process 350 advances to step 358 where the application server 102 updates the service incident record to reflect that the service incident has been reported as irresolvable, thereafter the process 350 exits. If the update message does not contain this information, the process 350 advances to step 360.

At step 360, the process 350 determines whether the data analysis service incident update message contains information indicating a proposed resolution to the service incident. If the update message contains such information, the process 350 advances to step 362 where the application server 102 updates the service incident record accordingly and the process 350 exits. Otherwise, the process 350 advances to step 364, where the process 350 reports an error due to improper information contained in the update message, and the process 350 exits.

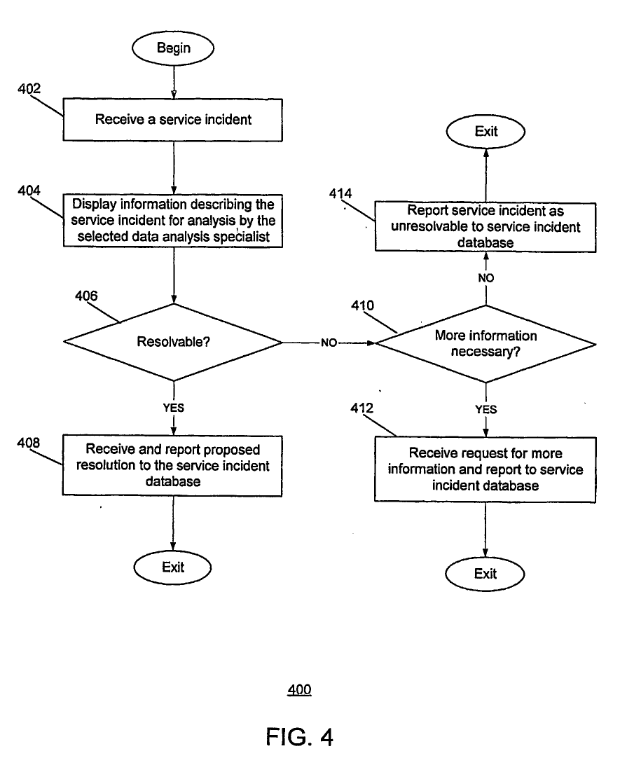

FIG. 4 illustrates a process 400 whereby the data analysis system 140 receives data analysis service incident messages from the application server 102 and processes the data analysis service incident messages accordingly. The process 400 begins at step 402 when the data analysis system 140 receives a data analysis service incident message from the application server 102. The data analysis service incident message contains information describing a service incident and an indication of a selected data analysis specialist.

At step 404, the data analysis system 140 displays information relevant to the service incident to the specialist terminal of the selected data analysis specialist. The selected data analysis specialist reviews the information displayed by the data analysis system 140 and may alter the data in various ways to attempt to determine a solution to the issue confronted and described by the user. Upon completion of review, the selected data analysis specialist indicates that his or her review of the service incident is complete and the process 400 advances to step 406.

At step 406, the process 400 prompts the selected data analysis specialist to indicate whether the service incident was resolvable given the information contained in the data analysis service incident message. If the service incident was irresolvable given the available information, the process 400 advances to step 410. Otherwise, the process 400 advances to step 408. The selected data analysis specialist is given an opportunity to describe a proposed resolution to the service incident, and the data analysis system 140 transmits a data analysis service incident update message to the application server 102 for storage in the appropriate service incident record in the service incident database 104. The data analysis service incident update message contains at least the proposed resolution to the service incident and an indication that a proposed resolution to the service incident has been provided. Once the data analysis service incident update message is transmitted to the application server 102, the process 400 exits.

At step 410, the process 400 prompts the selected data analysis specialist to indicate whether the service incident was irresolvable due to insufficient information. If the service incident was irresolvable due to insufficient information, the process 400 advances to step 412 and the selected data analysis specialist is given an opportunity to specify a request of additional information from the user. The data analysis system 140 presents the selected data analysis specialist with a text box, within which the selected data analysis specialist can describe the type of information the selected data analysis specialist needs to propose a resolution to the service incident. Upon receipt of this additional information, the data analysis system 140 transmits a data analysis service incident update message to the application server 102 for storage in the appropriate service incident record in the service incident database 104. The data analysis service incident update message contains at least the request for additional information necessary to resolve the service incident and an indication that additional information is required to resolve the service incident. Once the service incident message is transmitted to the application server 102, the process 400 exits.

If the service incident was irresolvable due factors other than insufficient information, the process 400 advances to step 414 and the selected data analysis specialist is given an opportunity to describe the reasons why the service incident is irresolvable. The data analysis system 140 presents the selected data analysis specialist with a text box. The selected data analysis specialist may describe the reasons the service incident is irresolvable. Upon receipt of this additional information, the data analysis system 140 transmits a service incident message to the application server 102 for storage in the appropriate service incident record in the service incident database 104. The data analysis service incident update message contains at least the reasons the service incident is irresolvable and an indication that the service incident is irresolvable. Once the data analysis service incident update message is transmitted to the application server 102, the process 400 exits.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

We claim:

1. A method for resolving a service request, comprising the steps of:
receiving a service request including information describing select attributes of a software application initiated by a user;
generating a service request response; and
sending the service request response to the received service request describing at least one reason for the current condition of the select attributes of the software application.

2. The method of claim 1, further comprising the steps of:
assigning a data analysis specialist to review the service request prior to the generation of the service request response;
generating a service request analysis message based upon the information contained within the service request;
sending the service request analysis message to the data analysis specialist; and
receiving a service request analysis response from the data analysis specialist, wherein said step of generating the service request response includes utilizing the information contained within the service request analysis response.

3. The method of claim 1, wherein the select attributes of the software application include data requested by the user.

4. The method of claim 1, wherein the select attributes of the software application include a report generated by the software application responsive to a data query to at least one database.

5. The method of claim 1, wherein the select attributes of the software application include software application settings.

6. The method of claim 5, wherein the software application settings include instance specific settings.

7. The method of claim 5, wherein the software application settings include global settings, which remain the same upon each instantiation of the software application.

8. The method of claim 1, wherein the receiving step is followed by the steps of:
generating tracking information describing various attributes of the service request; and
storing the information contained in the service request and the tracking information in a service request record on a data storage device.

9. The method of claim 8, wherein the tracking information includes the time the service request was initiated and the time the service request was resolved.

10. The method of claim 8, wherein the service request record is stored in a database.

11. A system for resolving a service request, comprising:
a server configured to receive a service request including information describing select attributes of a software application initiated by a user, to generate a service request response, and to send a service request response describing at least one reason for the current condition of the select attributes of the software application, wherein the server includes:
a processor configured to generate tracking information describing various attributes of the service request, assign a data analysis specialist to review the service request, and generate a service request analysis message based upon the information contained within the service request; and
a database coupled to the processor and configured to store the information contained in the service request and the tracking information in a service request record on a data storage device; and
a data analysis system in communication with said server and configured to receive the service request analysis message and send a service request analysis response generated by the data analysis specialist, wherein the processor receives the service request analysis response and generates the service request response based upon the information contained within the service request analysis response.

12. The system of claim 11, wherein the select attributes of the software application include data requested by the user.

13. The system of claim 11, wherein the select attributes of the software application include a report generated by the software application responsive to a data query to at least one database.

14. The system of claim 11, wherein the select attributes of the software application include software application settings.

15. The system of claim 14, wherein the software application settings include instance specific settings.

16. The system of claim 14, wherein the software application settings include global settings, which remain the same upon each instantiation of the software application.

17. The system of claim 11, wherein the tracking information includes the time the service request was initiated.

18. A logic arrangement for accessing data, wherein the logic arrangement is adapted for an execution by a processing arrangement to perform the steps comprising of:
receiving a service request including information describing select attributes of a software application initiated by a user;
generating a service request response; and
sending the service request response to the received service request describing at least one reason for the current condition of the select attributes of the software application.

19. The logic arrangement of claim 18, wherein the select attributes of the software application include data requested by the user.

20. The logic arrangement of claim 18, wherein the select attributes of the software application include a report generated by the software application responsive to a data query to at least one database.

21. The logic arrangement of claim 18, wherein the select attributes of the software application include software application settings.

22. The logic arrangement of claim 21, wherein the software application settings include instance specific settings.

23. The logic arrangement of claim 21, wherein the software application settings include global settings, which remain the same upon each instantiation of the software application.
